(19) United States
(12) Patent Application Publication
(10) Pub. No.: US 2005/0039585 A1
(43) Pub. Date: Feb. 24, 2005

(54) In-line punching system

(75) Inventors: Thomas Battisti, Buffalo Grove, IL (US); James Sander, Arlington Heights, IL (US); Nick Tiamson, Chicago, IL (US); James Russo, Chicago Heights, IL (US); Phillip Crudo, Round Lake, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: General Binding Corporation, Northbrook, IL (US)

(21) Appl. No.: 10/923,624

(22) Filed: Aug. 20, 2004

Related U.S. Application Data
(63) Continuation of application No. PCT/US03/04962, filed on Feb. 21, 2003.
(60) Provisional application No. 60/358,632, filed on Feb. 21, 2002.
(60) Provisional application No. 60/387,664, filed on Jun. 11, 2002.

(51) Int. Cl. B26D 1/00

(52) U.S. Cl. 83/13; 83/684

(57) ABSTRACT

A punching station that utilizes low cost, interchangeable, linearly operating die sets, and may be disposed in line with a printer to punch individual sheets as they proceed through the printer. Sheets exiting a printer or other machine are rapidly accelerated along a circuitous path in the punching station, and then into position between the die plates of a linearly actuated die. The sheet is stopped and punched, and then rapidly accelerated out of the punch to exit the punching station. Each sheet is accelerated to a speed that is typically greater than the speed of the sheet as it exits the printer. Die sets having different pin sizes and configurations are interchangeable within the punching station in order to permit rapid die changes, and the die pins are preferably made of powdered metal to yield low cost die sets.

### CROSS REFERENCE TO RELATED APPLICATIONS

This patent application is a continuation of international patent application number PCT/JUS03/04962 filed Feb. 21, 2003, which claims the benefit of U.S. provisional patent application No. 60/387,664 filed Jun. 11, 2002, and also claims the benefit of U.S. provisional patent application No. 60/358,632 filed Feb. 21, 2002.

### FIELD OF THE INVENTION

The invention relates to die punching machines, and more particularly to die punching stations that are disposed in-line with a printer.

### BACKGROUND OF THE INVENTION

It is frequently desired to punch printed sheets in a printing system. To this end, a stack of printed sheets may be transported to a separate punching station or machine. The use of such separate machines, however, entails considerable expense, both in the capital investment and upkeep of the machine, and the labor and time involved in such movement of printed stacks.

Accordingly, punching stations are sometimes disposed in line with the printing machine itself, punching individual sheets as they exit from the printer. While the labor involved is reduced considerably in such arrangement, the stations themselves are generally expensive inasmuch as they utilize high cost precision dies in order to obtain quality punching at high volumes. Typically, current in-line systems utilize rotary and linear methods with a one punch arrangement that provides for one, two, three or four holes. Rotary punch machines typically utilize precision rotary punches wherein each individual sheet is passed between a punch wheel having protruding die pins, and a die wheel having mating openings for receiving the punch pins. In this way, the papers continually advance through the system, as opposed to advancing into position in a linear die, stopping, being punched by the linear die, then advancing out of the punch.

Unfortunately, however, such typical in-line arrangements are not only expensive, but also, modifying the punching arrangement is extremely difficult, laborious, and time-consuming. For example, in a rotary system, the rotary die wheels are both driven, and the attached gearing mechanism, drive motor, and timing arrangement present a complex structure that is not readily disassembled for die changes. Typical linear die arrangements likewise involve complex ram arrangements. Accordingly, the rotary or linear dies, and therefore the punching arrangement, are not often changed unless necessitated by damage to the punches themselves. That being the case, the punching arrangement, hole size, shape, and number are not typically varied between printing or punch jobs. As a result, a system that provides for various multi-hole arrangements with low-cost, easily interchangeable dies is desirable.

Inasmuch as such punches are typically set up for a given paper size, Jams and misfeeds often result from the feeding of miss-sized paper. Necessary cleaning or clearing of paper jams or misfeeds may likewise cause expensive repairs and work delays. Complex punching arrangements may increase the difficulty or cumbersome nature of such cleaning and clearing. Thus, it is desirable not only that a punching arrangement be easily maintained and repaired, but that such jams and misfeeds be prevented or minimized if possible.

### OBJECTS AND SUMMARY OF THE INVENTION

Accordingly, it is a primary object of the invention to provide a low cost, yet high quality, alternative to present in-line punching arrangements. It is a related object to provide an in-line punching arrangement wherein the die set may be rapidly and inexpensively changed to allow repair or modification of the punching arrangement.

It is a another object of the invention to provide a low cost punching system which provides added versatility in that a single punching machine may be readily set up to punch any number of punching arrangements.

It is a further object of the invention to provide a low cost die set, low cost die pin arrangement, and low cost die pins themselves.

It is yet another object of the invention to provide a punching system that may be easily serviced and maintained, and that minimizes or substantially eliminates jams or misfeeds and mispunches that may result from improper usage.

In keeping with these and other objects of the invention, there is provided a punching station that may be disposed in line with a printer to punch individual sheets as they proceed through the printer. The punching station utilizes low cost, interchangeable, linearly operating die sets. Sheets typically exiting the printer are rapidly accelerated along a circuitous path in the punching station, and then into position between the die plates of a linearly actuated die. The paper is stopped and punched, and then rapidly accelerated out of the punch to exit the punching station. The paper may then go on to a stacking tray or collating device. It is this circuitous or lengthened route, in combination with the rapid movement of the sheet, which permits the use of the linearly actuated die, as opposed to a rotary die arrangement, while maintaining the normal movement of the sheet through the entire processing machine. Moreover, the punching station preferably includes a pair of sensors adapted to sense the passage of a sheet such that the speed, and ultimately the length of a passing sheet may be calculated. If an improper sheet size is passed, the station is set to automatically pass the sheet through the punching station without actuation of the die set to punch the sheet.

According to another feature of the invention, the die sets themselves are interchangeable within the punching station in order to permit rapid die changes. To this end, the interchangeable dies are received in channels within the punching station adjacent a linearly actuated ram.

The dies themselves preferably include one or more thin sheet metal die plates, which allow the close spacing of multiple die holes. Further, the die pins themselves are preferably formed of powdered metal. The powdered metal pins may be individually formed with a shaft and head, or a plurality of pins may be formed unitarily with a punch pin plate from powdered metal. In arrangements where the individual pins are formed from powdered metal, individual pins may be readily replaced if worn or damaged, while the entire pin plate would be replaced in a unitarily formed arrangement. The powdered metal pins, however, have a relatively low cost, and are more easily fabricated than the traditional machined die pins utilized in punching arrangements. Moreover, the low cost nature of the die sets themselves allows the user to maintain a plurality of die sets having varied pin shapes and arrangements, permitting high quality in-line punching and substantially any desired punch arrangement.

These and other features and advantages of the invention will be more readily apparent upon reading the following description of a preferred exemplified embodiment of the invention and upon reference to the accompanying drawings.

### BRIEF DESCRIPTION OF THE DRAWINGS

FIG. 1 is a schematic perspective view of a printing arrangement including a punching station.

FIG. 2 is a fragmentary enlarged view of the punching station of FIG. 1.

FIG. 3 is a schematic perspective view of a rotary die arrangement of the prior art.

FIG. 4 is a cross-sectional view of a punching station constructed in accordance with teachings of the invention.

FIG. 5 is an alternate embodiment of the punching station of FIG. 4 constructed in accordance with teachings of the invention.

FIG. 6 is an alternate embodiment of the punching station of FIGS. 5 and 6 constructed in accordance with teachings of the invention.

FIG. 7 is a perspective view of a die set of the prior art.

FIG. 8 is an end view of a die set of the prior art.

FIG. 9 is a perspective view of a die set constructed in accordance with teachings of the invention.

FIG. 10 is a fragmentary perspective view of the die set of FIG. 9.

FIG. 11 is an enlarged perspective view of a powdered metal punch pin.

FIG. 12 is an enlarged end view of the die set of FIG. 9.

FIG. 13 is a perspective view of a powdered metal punch pin plate constructed in accordance with teachings of the invention.

FIG. 14 is a perspective view of an alternate embodiment of a die set constructed in accordance with teachings of the invention.

FIG. 15 is a side elevational view of the die set of FIG. 14.

FIG. 16 is an enlarged end elevational view of the die set of FIG. 14.

FIG. 17 is an exploded, perspective view of the die set of FIG. 14.

FIG. 18 is an enlarged, fragmentary, perspective view of the aligner for use in a punching or other processing station.

### DETAILED DESCRIPTION OF THE PREFERRED EMBODIMENTS

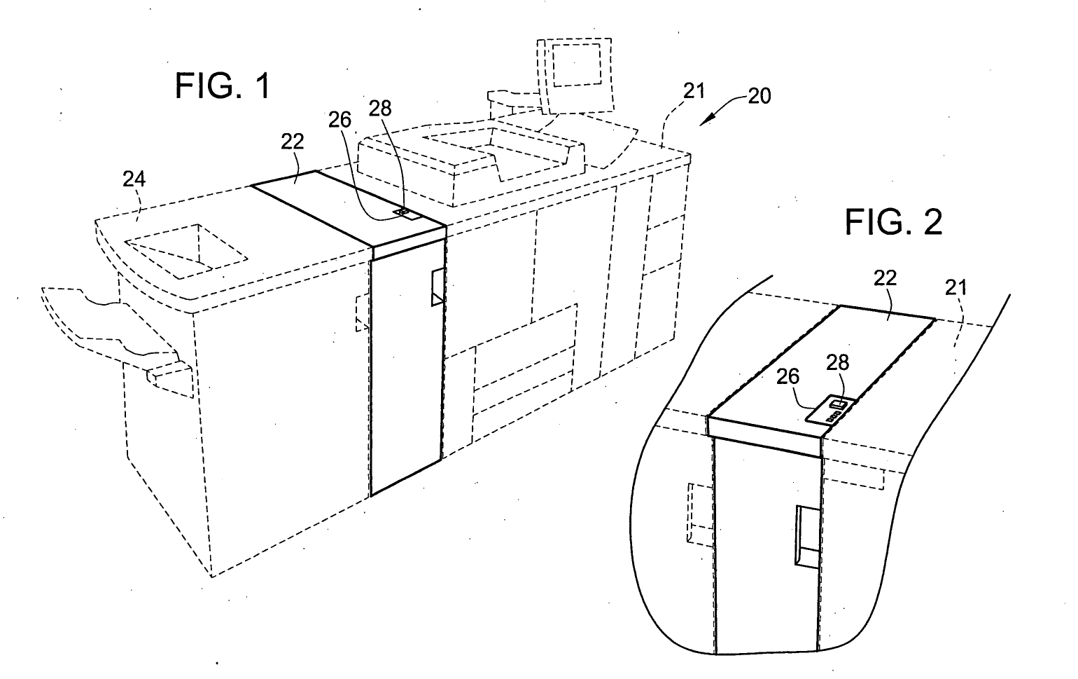

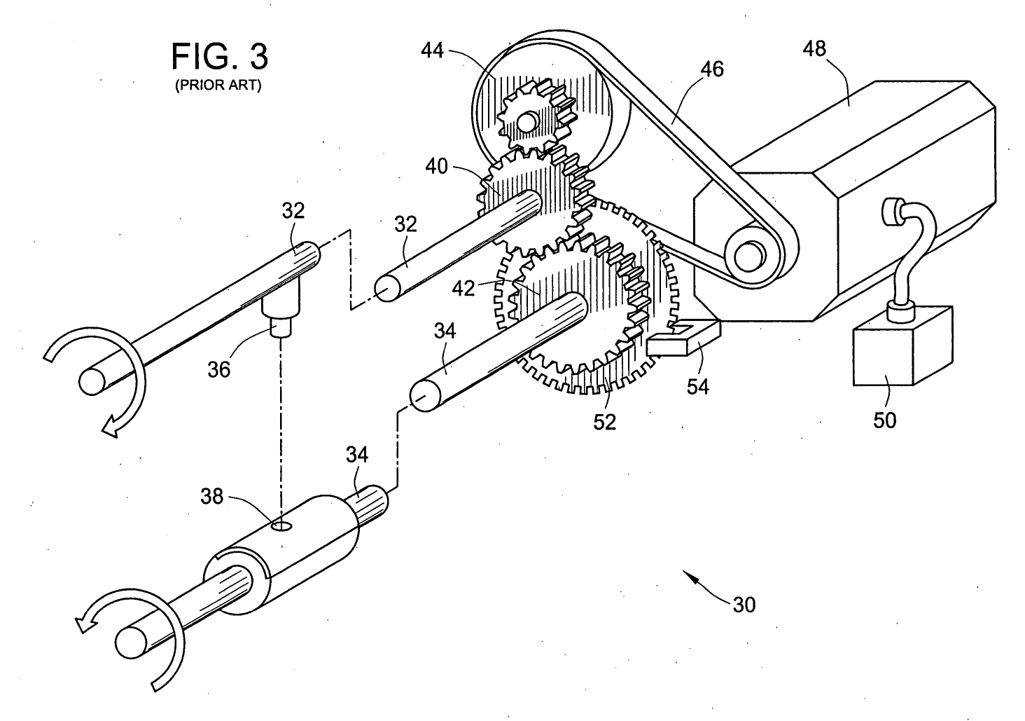

Turning now to the drawings, there is shown in FIG. 1 a printing machine 20 which includes a punching station 22. The punching station 22 is disposed within the printer arrangement 20 such that documents exiting the printer 21 may proceed through the punching station 22 before reaching the final processing station, which may be, for example, a collating or stacking station 24. The punching station 22 includes a control pad 26 having on and off switches, as well as an emergency cut-off button 28.

A schematic view of a punching arrangement 30 of the prior art is shown in FIG. 3. This rotary punching arrangement includes a pair of rotating axes 32, 34 that include a plurality of male punches 36 and a plurality of mating female dies 38, respectively. For the sake of simplicity, only one of each of the male punches 36 and mating female dies 38 are illustrated. It will be appreciated, however, that a plurality of such punches 36 and dies 38 are typically contained in the punching arrangement 30. Both axes 32, 34 are journaled in and driven by mating gears 40, 42 coupled by a gearing system 44 and a belt 46 to a motor 48, which is electrically coupled to a control board 50. A timing disk 52 indexes and controls the start position of these axes 32, 34 in response to signals from an opto coupler 54, which is coupled to the motor 48. In use, papers exiting from the printer advance between the rotationally disposed male punch 36 and female die 38 as they rotate on axes 32, 34.

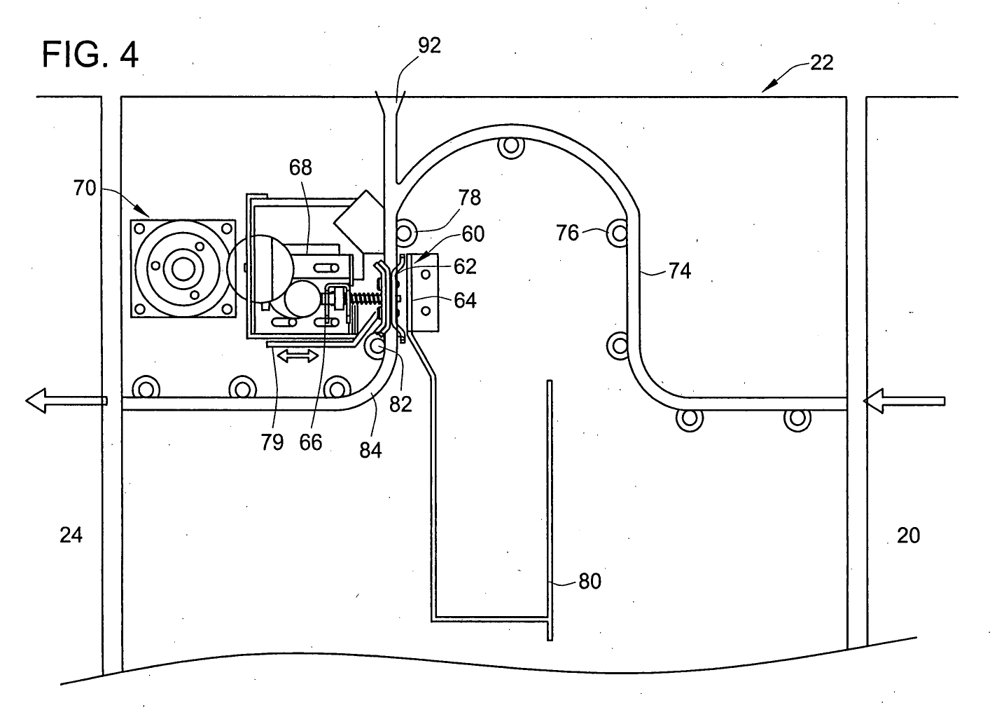

In accordance with the invention, the punching station 22 of the proposed design preferably includes a linearly actuated die set 60 as opposed to such rotary die set arrangements (see FIG. 4). The die set 60 is generally disposed such that the lower surface 62 of the die set 60 is supported against a stationary support 64 while an upper surface 66 is engageable by a linear actuator 68. The linear actuator 68 may be of any type, including those having a ram actuated by a gearing mechanism 70. Although traditional in-line punching arrangements typically utilize rotary or linear arrangements that provide for one, two, three, or four holes, an important feature of the invention is the provision of low-cost, easily changed dies that allow for various multi-hole punching arrangements, not limited to one, two, three, or four hole arrangements.

As sheets exit from the printer 20, they are received and advanced along a paper path 74 by a plurality of driven rollers 76 into the die set 60. The forward movement of the sheets is then arrested by the backgage sheet stop 79, which may slide into the paper path to stop the sheets. The sheets are then punched by the linearly operating die set 60. The scraps of paper punched from the sheets fall via gravity into a removable chip bucket 80. The backgage sheet stop 79 then moves out of the paper path so the sheets may be moved out of position in the die set 60 by driven rollers 78, 82 along the exit paper path 84 to exit the punching station 22 and proceed to a collating or stacking station 24 or other output device.

According to an important feature of the invention, utilization of the punching station 22 does not slow or significantly slow sheet processing. To this end, the sheets exiting the printer 20 are rapidly accelerated along the paper path 74 as the sheets are advanced into position in the die set 60. It will be appreciated that in subsequent processing machines, the second machine typically accepts and moves a sheet forward at a slightly accelerated speed relative to the previous machine in order to maintain sufficient tension on the sheet to move it smoothly through the system. This speed variation is normally on the order of one to two percent. According to the invention, however, the sheet is taken up and accelerated at a significantly faster speed. While a speed that is on the order of five times the speed necessary to maintain tension may be adequate (i.e., the punching machine accelerating the sheet to a speed that is 10% faster than the printer), the sheet is preferably accelerated to a speed on the order of twice as fast as the linear speed of the sheet exiting the printer.

In this way, operation of the punching station 22 in-line with the printer 20 does not interfere with the normal operation and speed of the printer 20. For example, a sheet exiting the printer typically moves on the order of 23 inches per second. It is presently envisioned that the sheet will be accelerated to a speed of 65 inches per second along an elongated path into position in the die set 60 where the paper pauses within the punch position on the order of 0.4 seconds in order to allow actuation of the die set 60. The punched sheet is then advanced through the exit paper path 84 at a speed essentially the same as the speed from which it exited the printer 20, i.e., on the order of 23 inches per second. Thus, the rapid acceleration of the printed sheet along the elongated path 74 sufficiently spaces the sheets to allow a momentary dwelling of the sheet at the die set 60. It will be noted that the paper path 74 is elongated and looped or arched in order to permit this spacing of the sheets in a relatively narrow punching station 22 (as shown in FIG. 1). It will also be appreciated that alternate loop-type circuitous paths may be provided, and these exemplary speeds and times may be varied in accordance with the spirit of the invention. Further, even though the currently preferred designs utilize a number of rollers for advancing a sheet through the punching station, alternate transport arrangements, including belts or the like may be utilized.

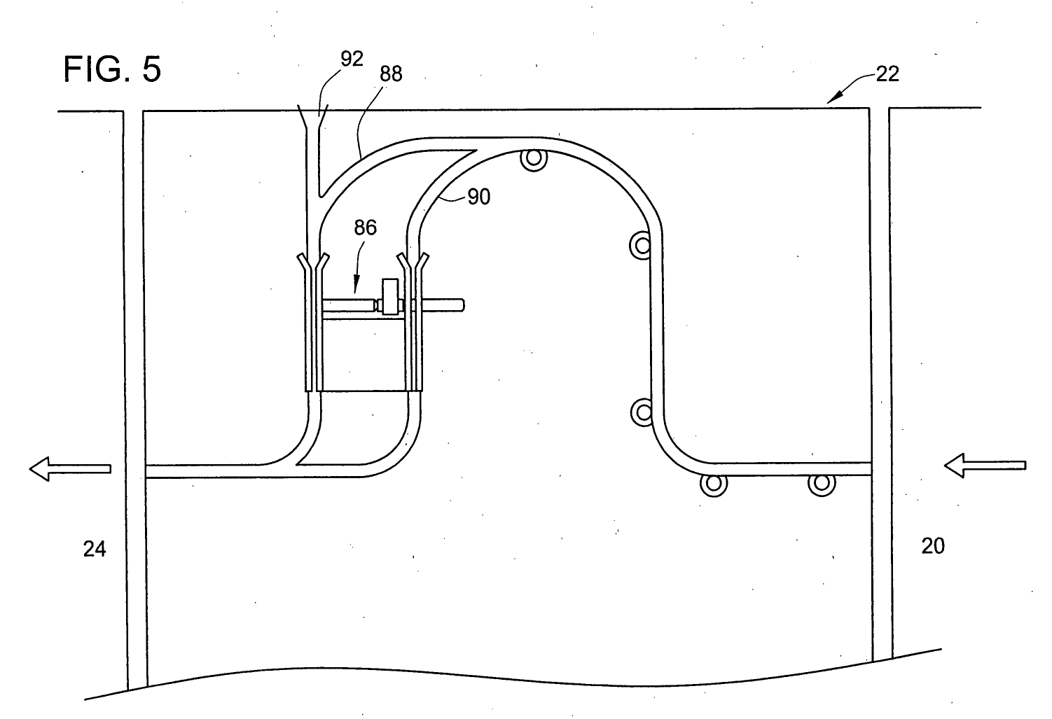

FIG. 5 illustrates an alternate arrangement, wherein a bi-directional punch 86 may be provided, and the accelerated sheets fed to alternate sides of the bi-directional punch 86 along dual paper paths 88, 90. It will be appreciated, however, that when utilizing a bi-directional punch that the sheets may be moved through the punching station at substantially the same or at an only slight greater speed than the sheets as they exit the printer.

As illustrated in FIGS. 4 and 5, to allow for the punching of sheets that have not proceeded through the printer 20 itself, the punching station 22 may include an auxiliary punch throat 92. In this way, unprinted or alternately printed sheets, such as covers or separating sheets, may be fed through the auxiliary punch throat 92 directly into the path 74 and into position in the die set 60 for punching.

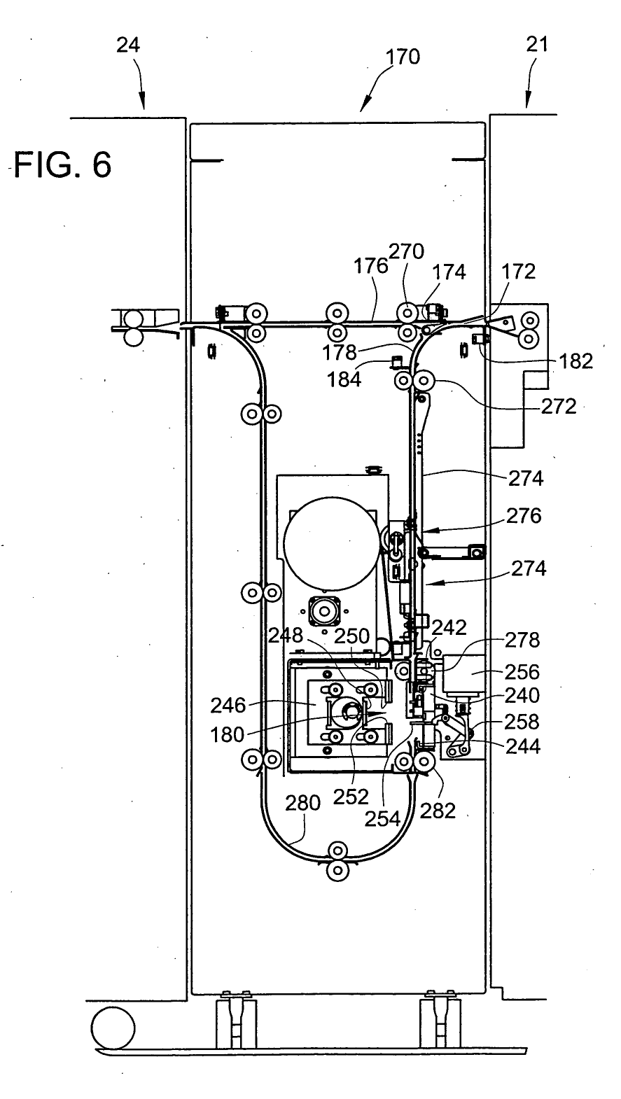

In accordance with another feature of the invention, the punching station 22 may be set up not only to permit bypass of the die punch path in its entirety, but also passage without punching of individual sheets of a group being processed. In the embodiment of a punching station 170 shown in FIG. 6, sheets exit the printer along paper path 172. A pivotably mounted diverter 174 then directs the sheets along either a bypass path 176, which directs the sheet to the next station or exit, or a die punch path 178, which directs sheets toward the die punch disposed at a position 180 along the punch path 178. Thus, depending upon the disposal of the diverter 174, the sheets are directed either to the next station or to the punch 180. During the normal use of the punching station 170, however, the operator presets the diverter 174 in the desired position for a group of sheets being processed.

In order to provide the operator with additional flexibility, however, the punching station 170 may be set up for a given group to punch only sheets of a given length, even if the diverter 174 is set to direct all sheets of the group toward the die punch path 178. In this way, for example, if the punching station 170 is set up to punch 8½″ by 11″ paper along the 11″ side, off-sized papers, that is, papers that are shorter or longer than 8½″, will pass along the die punch path 178 without being punched by the punch 180.

In accomplishing this method of operation, the punching station 170 is provided with a pair of sensors 182, 184 that are disposed in spaced relation to one another along the paper path 172 and/or the bypass path 178. In the illustrated embodiment, the first sensor 182 is disposed along the paper path 172 exiting the printer, and the second sensor 184 is disposed along the die punch path 178. Both sensors 182, 184 are adapted to sense the passage of a sheet, and at least one of the sensors 182, 184 is adapted to sense both a first edge and a second edge of a single sheet as it passes the sensor 182, 184. Thus, the speed of the sheet travel may be calculated from (i) the measured passage of time for a single sheet to pass between one sensor 182 and the next 184 and (ii) the known distance between the sensors 182, 184. Further, the length of a single sheet may be calculated from (i) the measured passage of time for the first edge of a single sheet to pass the at least one of the sensors 182, 184, and (ii) the calculated speed of sheet travel. It will be appreciated by those of skill in the art that this arrangement may be utilized for essentially any punching station 170 set-up in order to substantially eliminate paper misfeeds or punch jamming due to the punching of incorrect paper sizes. It will further be appreciated that the first and second edges can be the leading and trailing edges, respectively, or the second and first edges may be the trailing and leading edges, respectively. Similarly, in determining is the sheet is the appropriate size, the first and second edges may be measured by the same sensor or by different sensors.

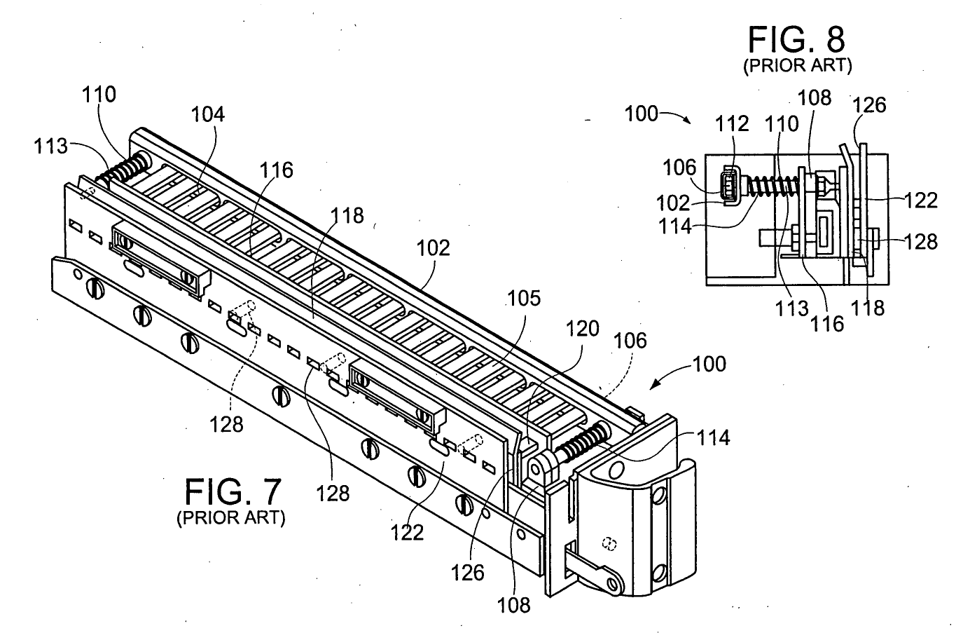

According to another important feature of the invention, the die sets 60 themselves are relatively low cost interchangeable items. As shown in FIGS. 7 and 8, current interchangeable die sets 100 typically include high cost, high precision materials. The interchangeable die set 100 shown in FIGS. 7 and 8 includes a die pin retainer 102 having openings 104 for receiving a plurality of die pins 105. In die set 100 illustrated, the die pins 105 themselves are rectangular, and each opening 104 receives a group of three die pins 105. The die pins 105 are further secured in position in the die pin retainer 102 by a retaining bar 106 disposed along the heads of the die pins 105.

The die pin retainer 102 is slidably coupled to a frame member 108 by one or more locking bolts 110, the bolt heads 112 being disposed along the upper surface of the die pin retainer 102, and the smooth surface shafts 113 extending through the die pin retainer 102 and being secured to the frame member 108. The die pin retainer 102 is biased away from the frame member 108 by springs 114 disposed about the shafts 113 of the locking bolts 110, or the like.

The die pins 105 are maintained in their defined path by upper and lower alignment plates 116, 118, which each comprise openings 120 through which the elongated shafts of the die pins 105 extend. Disposed parallel the alignment plates 116, 118 is a die plate 122 having openings 124 which further correspond to the die pins 105, the lower alignment plate 118 and the die plate 122 defining a throat 126 therebetween for receiving the sheet to be punched. The relative positions of the upper and lower alignment plates 116, 118, and die plate 122 may be maintained by a plurality of steel shims or spacers 128, or the like. While the die set 100 provides a highly durable interchangeable die arrangement, the device is relatively expensive to manufacture, as are other known interchangeable die sets, inasmuch as they involve the use of thick die plates, machined blocks of steel, and precision machined die pins.

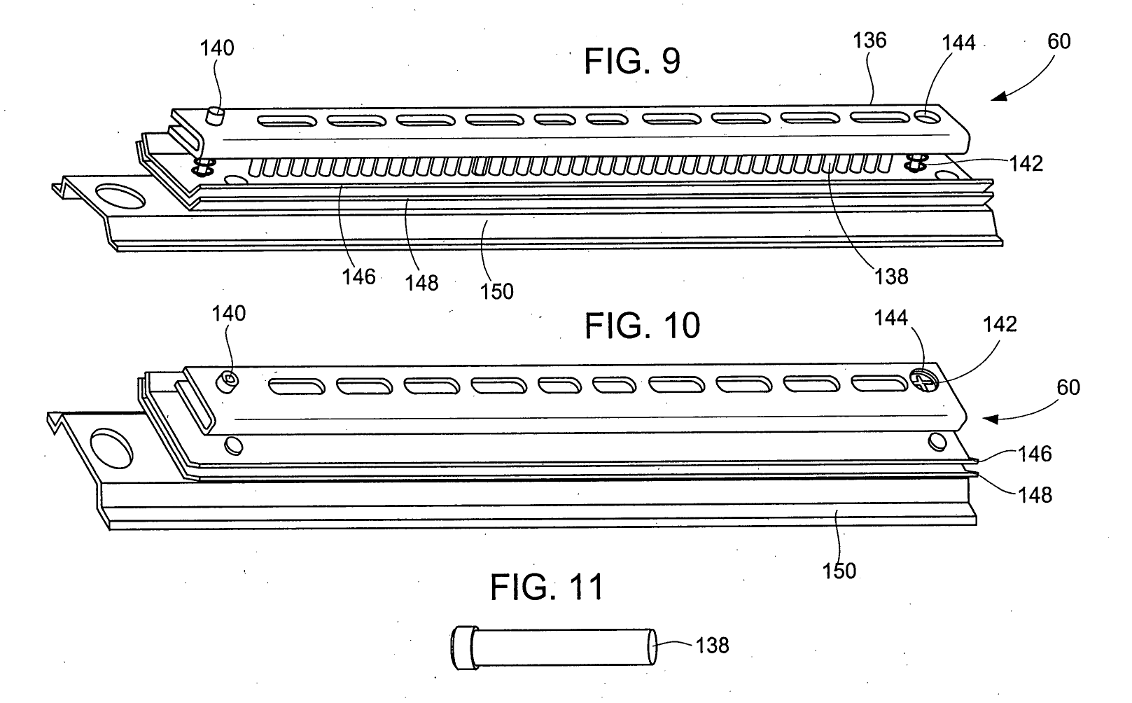

According to an important aspect of the invention, however, die sets constructed according to teachings of the invention are not only interchangeable, but they are also low cost structures. As shown in FIG. 9 and in the partially exploded view of FIG. 10, the die set 60 includes plates that are made of thin, formed sheet metal. It is currently envisioned that the sheet metal plates may typically be on the order of 0.048-0.125 inches thick, although it will be appreciated that alternate thicknesses may be used without deviating from the inventive scope. The thin plate allows the precision stamping of not only alignment openings, but also the openings in the lower die plate at a considerably lower cost than the existing methods of constructing die sets. More specifically, the die set 60 includes a U-shaped channel 136 which acts as both a die pin retainer and retaining bar, the heads of the pins 138 themselves being disposed within the channel. Alternatively, the die pin retainer and retaining bar may be two separate elongated rectangular pieces disposed above and below the die pin heads. It will be appreciated, however, that the U-shape provides added strength in the case of the combination die pin retainer and retaining bar.

As with the prior art structure, the U-shaped channel retaining the die pins 138 is coupled to the remainder of the die set 60 by one or more locking bolts 140, 142. In this design, however, the head of one of the locking bolts 140 is disposed along the upper surface of the upper leg of U-shaped channel 136, while the head of the second locking bolt 142 is disposed along the upper surface of a lower leg of the U-shaped channel 136, the head of the locking bolt 142 being accessible through an enlarged bore 144 in the upper leg of the U-shaped channel 136.

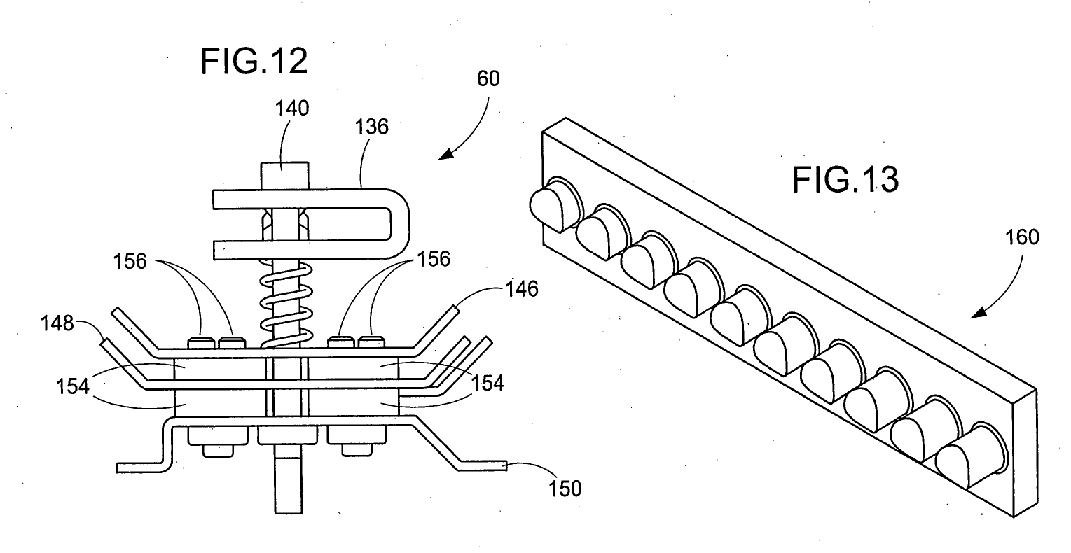

The upper and lower alignment plates 146, 148, and the die plate 150 are simple stamped structures which are also formed of sheet metal. As best seen in FIG. 12, spacing between the upper and lower alignment plates 146, 148, and die plate 150 is maintained by small shims 154, and a plurality of bolts 156 extending therethrough to secure the plates 146, 148, 150 and shims 154 together in their respective positions. It will be appreciated that, in use, at least a portion of the plates 146, 148, 150 are received in channels, rails, or the like within the punching station 22 to couple the die set 60 to the station 22. In use, the ram, or other actuator, bears against the upper surface of the U-shaped channel 136 or other pin retaining arrangement to linearly actuate the die set 60 and punch a sheet.

Turning now to FIGS. 11 and 13, according to another important feature, rather than expensive machined punch pins, the low cost interchangeable die set 60 includes a plurality of punch pins 138 formed from powdered metal by conventional forming techniques. In this way, the punch pins 138 may be economically formed to precise dimensions and shapes without the expense of precision machining the individual pins. While the strength and durability of the powdered metal punch pins 138 may be less than that of machined pins, the pins 138 are uniformly required to punch only a single sheet at a time, such that a high strength is not generally required. Moreover, it is believed that the cost savings with powdered metal pins more than adequately offset the cost of more frequent replacement. Further, use of powdered metal to form the punch pins provides improved flexibility in forming the designs of the punch pins at a reasonable cost. For example, elongated punch pin plates 160 which include a base plate from which a plurality of punch pins extend may be readily and inexpensively unitarily formed, as shown in FIG. 13. In contrast, machining the same number of punch pins extending from a single punch pin plate can greatly increase the cost of traditional machined punch pin arrangements.

The punch pins or punch pin plates may be formed from any appropriate powdered metal technique. For example, the powdered metal may be introduced in either a cold or heated form and compacted into a die and subsequently heated or otherwise sintered to form the punch pin or punch plate. Alternately, the cold powdered metal may be compacted in a press to produce a powder preform, which is subsequently sintered in a controlled-atmosphere furnace. The sintered part may then be allowed to cool in the sintering atmosphere (as in conventional powder metallurgy processes) or removed from the furnace while it is still hot and forged in a closed die to produce the final shape.

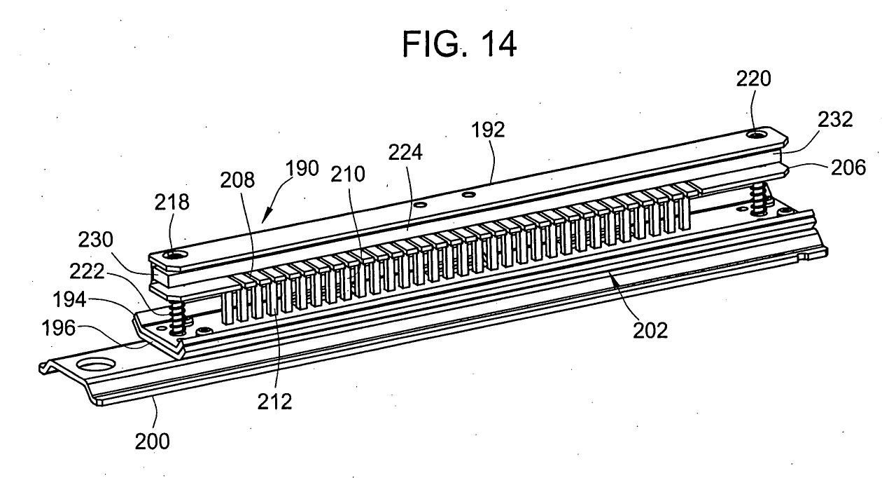

The currently preferred embodiment of an interchangeable die set 190 is shown in FIGS. 14-17. As with the die set 60 of FIGS. 9-12, the die set 190 of FIGS. 14-17 includes a U-shaped die pin guide/retainer 192, alignment plates 194, 196, spacers 198, and die plate 200 that are stamped steel structures formed of sheet metal. The spacers 198 are disposed between alignment plate 196 and the die plate 200 and define the throat 202 for receiving sheets during the punching process (or the passage of sheets without punching). The alignment plates 194, 196, spacers 198, and die plate 200 are secured together by screws 204, rivets or other coupling structure.

The lower arm 206 of the U-shaped die pin guide/retainer 192 includes a plurality of slots 208 for receiving the pins 210. The pins 210 themselves include a shaft 212 with a head 214 and a necked in portion 216 that may be received in the slots 208 to dispose the head 214 within the U-shaped channel of the die pin guide/retainer 192, with the shaft 212 extending downward from the lower surface of the lower arm 206. The die pin guide/retainer 192 is slidably coupled to the alignment plates 194, 196 and die plate 200 structure by shoulder bolts 218, 220, which are slidably received in bores in the die pin guide/retainer 192 and then secured to the alignment plates 194, 196 and die plate 200 structure. In order to bias the die set 190 into the open position, coil springs 222 are provided about the shoulder bolts 218, 220 between the die pin guide/retainer 192 and the alignment plates 194, 196 and die plate 200 structure.

Die punch arrangements typically include a mechanism by which the die pins themselves do not enter the sheet(s) simultaneously, that is, at least some of the perforations are typically punched in the sheet(s) in rapid successions, rather than all at the same time. To this end, die punches sometimes include various lengths of die pins such that all of the pins do not enter the sheet simultaneously. It will be noted that in FIG. 13, the pins of the punch pin plate 160 are of different lengths. In that embodiment, however, the punch pin plate 160 with the punch pins is unitarily formed of powdered metal, yielding a relatively economical pin arrangement that provides such sequential punching. Alternately, however, the punch may include a pressure bar that has a plurality of offset steps that do not initiate a punching force on all of the pins at the same time. It will be appreciated, however, that such die and punching arrangements can be quite complex and costly to machine due to the complex pressure bar structure or the machining of various lengths of die pins.

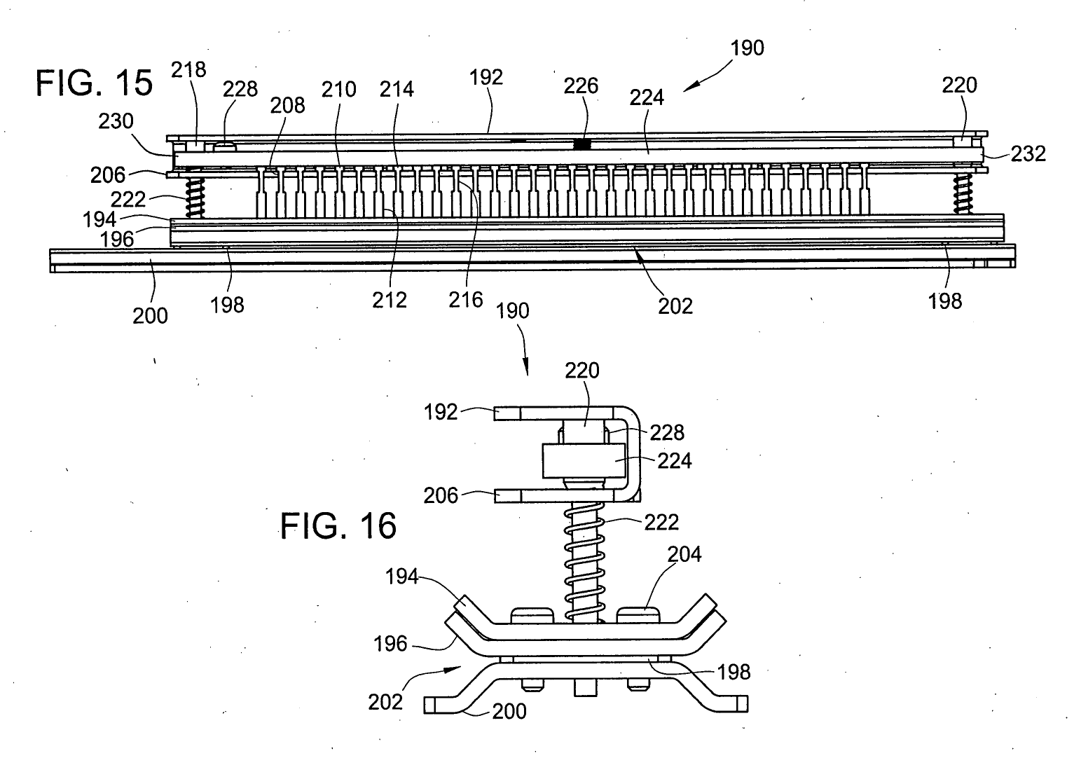

According to another feature of the invention, however, the die set 190 comprises not only die pins 210 that all have substantially the same structure, but a self-contained mechanism for applying varied force to the pins 210 such that they do not all punch the sheet simultaneously. In accomplishing this varied force application, the die set 190 includes a pressure bar 224 that is coupled in the die set 190 such that it provides an automatic sequential perforation of the sheet by the die pins 210. As may best be seen in FIG. 15, the pressure bar 224 is disposed within the U-shaped channel of the pin guide/retainer 192 above the heads 214 of the pins 210. Bores in either end of the pressure bar 224 receive the shoulder bolts 218, 220 such that the pressure bar 224 can slide and tilt along the shafts of the shoulder bolts 218, 220 with the pin guide/retainer 192. The pressure bar 224 is biased toward the heads 214 of the pins 210 by a spring 226. In this arrangement, the spring 226 is a coil spring. The spring 226 may, however, be of an alternate design or the biasing mechanism may be of an alternate design, as is the case with the springs 222 that bias the die set 190 into the open position. It will be appreciated by those of skill in the art that at least one of the bores at each of either end of the pin guide/retainer 192 or the pressure bar 224 must be sized such that the heads of the shoulder bolts 218, 220 do not pass entirely through the combination pin guide/retainer 192 and pressure bar 224 do not readily separate from the die set 190 if the die set 190 is to be maintained as a self-contained structure that may be readily removed for replacement in the punching stations 170.

During the punching process, as the pin guide/retainer 192 is advanced toward the die plate 200, the distal ends of the shafts 212 of the, pins 210 contact the sheet to be punched. As a result, the sheet exerts a slight axial force on the pins 210, causing the pins 210 to exert a force on the pressure bar 224 against the biasing force of the spring 226. In order to limit the travel of the pressure bar 224, however, a spacer 228 is provided along the upper side of the pressure bar 224. Thus, as the pins 210 exert an upward force on the pressure bar 224, the pressure bar 224 moves upward within the U-shaped channel of the pin guide/retainer 192 until the spacer 228 arrests travel on one end 230 of the pressure bar 224. The pressure bar 224 then tilts, the opposite end 232 of the pressure bar 224 continuing to slide along the shoulder bolt 220 until such time as any movement of the pressure bar 224 is arrested. In this way, the canted pressure bar 224 causes the die pins 210 to rapidly and successively perforate the sheet. Upon removal of the ram force on the pin guide/retainer 192, the pins 210 retract from the die plate 200 and the sheet, and the pressure bar 224 returns to its original biased position. Thus, the controlled, automatic tilting of the floating pressure bar 224 relative to the pin guide/retainer 192 and the axes of the die pins 210 allows the utilization of pins 210 of a common length, reducing pin fabrication costs. The floating pressure bar 224 operates with a reduced actuation load, ultimately allowing the utilization of a smaller motor size for actuation of the ram. Further, the pressure bar 224 itself is relatively easily and inexpensively fabricated as compared to pressure bars having a plurality of offset steps.

Referring now to FIGS. 6 and 16, in order to receive the die set 190, a number of flanges are provided along the punch path 178 of the punching station 170. More specifically, the die plate 200 is slidably received between a support surface 240 and at least a pair of flanges 242, 244. In this way, the throat 202 is disposed in the die punch path 178 such that an advancing sheet is received in the throat 202 for punching or the sheet may be passed through in its entirety and not punched.

Similarly, the pin guide/retainer 192 is slidably received by the ram 246 between support surface 248 and flanges 250, 252. Thus, movement of the ram 246 (by whatever mechanism) and the coupled pin guide/retainer 192 relative to the die plate 200 results in the punching of a sheet contained in the throat 202 of the die set 190.

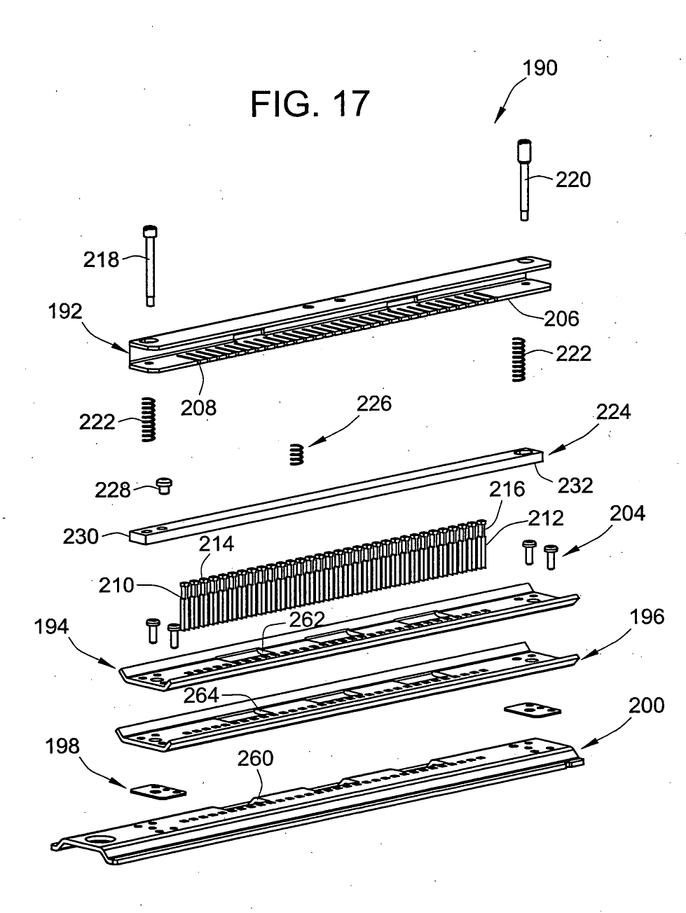

In order to arrest movement of a sheet as it passes along the die punch path 178, one or more blades 254 are provided. In the preferred embodiment illustrated, the movement of the blades 254 is provided by a motor 256 that is coupled to the blades 254 by a linkage arrangement 258, although the movement may be provided by any appropriate mechanism. In order to properly position the blades 254 to arrest and properly position the sheet, the die plate 200 and alignment plates 194, 196 are provided with openings 260, 262, 264, respectively, which are disposed to receive the blades 254, as may best be seen in FIG. 17.

Returning now to FIG. 6, in use, if the punching station 170 is set to such that it will not operate to punch the sheets, the diverter 174 will direct the sheet exiting the printer 21 (or other machine) to the bypass path 176 to exit the punching station 170 and continue on to the next operation 24. The rollers 270 along the bypass path 176 preferably match the speed of the sheet as it exits the printer 21.

Alternately, if the punching station 170 is set to punch sheets from a given group being processed, the diverter 174 is set to direct the successive sheets along the punch path 178. As a sheet exiting the printer 21 (or other machine) passes the first sensor 182, an initial speed reading is taken, followed by a second sensor 184 where a second speed reading is taken. The first sensor 182 likewise takes a reading as the tail end of the sheet passes the sensor 182. As previously explained, the readings are then compared to determine whether the passing sheet is the proper size to be punched. If it is not the proper size, the sheet will be passed through the die set 190 without punching, the blades 254 being in the retracted position to allow the sheet to pass. The sensor system likewise provides a signal to cause any necessary adjustment to a stepper motor for advancing the sheet through the punching station 170, if provided.

As the sheet continues along the punch path 178, it passes between the first set of rollers 272 as the sheet is transferred from the printer 21 to the punching station 170. It will be noted that the first set of rollers 272 is preferably a floating roller arrangement that forms a soft nip such that the rollers 272 do not tear the sheet from the printer 21 handling mechanism. Rather, the rollers 272 allow some slippage of the rollers 272 on the sheet as the sheet is driven by the printer 21 handling mechanism at a relatively slower speed, eliminating or minimizing any possible damage to the printer 21 as the rollers 272 of the punch station 170 take control of the sheet. As the sheet is released by the printer 21 handling system, the rollers 272 accelerate the sheet toward the die punch 190. (The first set of rollers 270 of the bypass path 176 may likewise form a soft nip to minimize the possibility for damage, if desired. Inasmuch as the speed of the bypass path 176 rollers 270 is preferably the same as the speed of the sheets exiting the printer 21, however, this may not be necessary.)

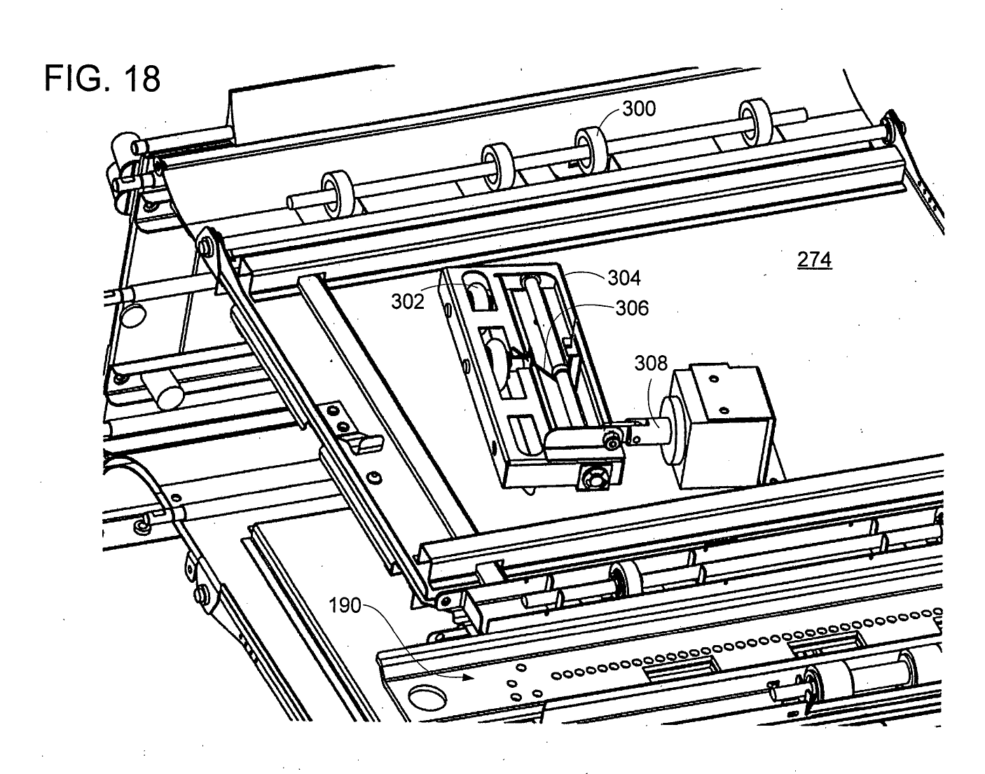

The sheet then moves through the angled aligner 274, which positions the sheet for punching within the die set 190. The angled aligner 274 includes floating rollers 276 that are formed of a very resilient and compliant material, allowing considerable flexibility in control of various types of stocks of sheets. The angled aligner 274 not only aligns the sheet for entry into the die set 190, but concurrently drives the sheet into the die set 190. As shown in the more detailed view of the angled aligner 274 shown in FIG. 18, as the sheet first enters the aligner 274, the rollers 300 control its movement. As the sheet progresses forward, the rollers 302 of the aligner module 304, which is normally based into engagement with the sheet by spring 306, engage and continue the forward movement of the sheet. The rollers 302 angle the sheet to one side as they move the sheet forward in order to ensure the sheet's proper placement in the die punch. In order to prevent or minimize any adverse tension on the sheet during its movement between the forward movement produced by the rollers 300 and the angled movement produced by the rollers 302 of the aligner module 304, however, there is preferably provided a solenoid 308 or other mechanical means to move the aligner module 304, and, therefore, the rollers 302 mounted thereon, out of engagement with the sheet until substantially such time as the rollers 302 will control the forward movement of the sheet. In this way the rollers 300 and rollers 302 do not conflict relative to the directions in which each moves the sheet. It will be appreciated that a similar angled aligner may be provided along the exit punch path 280 as well in order to properly position the punched sheet for passage to the next machine 24.

If the sheet is to be punched (as determined by the reading taken at the sensors 182, 184), the blades 254 are disposed to engage the die set 190, as explained above, such that the blades 254 arrest the forward movement of the sheet through the die set 190. In order to ensure that the sheet is properly positioned and remains properly positioned in the die set 190, compliant, floating rollers 278 are likewise provided that continue to drive the sheet into the die set 190, the rollers 278 slipping on the sheet as it is arrested in its position at the die set 190 by the blades 254. In this way, the sheet continues to be driven into the die set 190 by one or more of the rollers 278, yet the rollers 278 are allowed to slip against the sheet to prevent any buckling. After the actuation of the die set 190 to punch the sheet, the blades 254 move outward to allow the sheet to continue to pass along the exit portion 280 of the punch path 178. Significantly, the sheet is accelerated out of the die set 190 by rollers 282 to a speed in excess of the speed at which it exited the printer 21.

The last roller set 284 along the exit portion 180 of the punch path 178 is preferably controlled by a stepper motor such that, as the sheet moves through the last roller set 284, the roller set 284 decelerates or otherwise adjusts the speed of the sheet to match the speed of the subsequent processing station 24 (which is likely at the speed of the printer 21). Alternately (in particular, if no stepper motor is provided), the last roller set 284 may be disposed to provide a controlled buckling of the sheet as it enters the subsequent processing station 24. In this way, the defined path would be slightly shorter than the length of the sheet to allow a controlled buckling for a short period before it exits the last set of rollers 284 of the punching station 170. Thus, while various stepper motors may be provided to control the speeds of various rollers (for example, the roller set 272 matching the speed of the printer 21 exit, and then accelerating the sheet toward and through the angled aligner 276), the roller arrangement may alternately be designed to provide slippage or controlled buckling to accomplish essentially the same result at a lower cost.

In summary, the invention provides a low cost alternative for linear die sets. The inventive die set preferably includes powdered metal pins, as well as plates which are stamped and formed from sheet metal. In view of the relatively low cost, the user may maintain a number of die sets having various shaped holes and arrangements. The die set is inserted into the punching station by merely sliding it into position. Accordingly, the die set may be rapidly and inexpensively changed out to a new desired size, number, shape, and pin arrangement by merely replacing the entire die set. When utilized in an in-line arrangement in a printer, the punching station preferably rapidly accelerates the sheet to be punched from the previous operation, into the die set where the sheet is stopped and punched. The sheet is then rapidly accelerated out of the die set and onto the subsequent operation. Thus, the punching station provides an efficient manner of handling the sheet to be punched while the low cost interchangeable die set provides extreme versatility to the user, as well as considerable savings in material and labor over traditional rotary and linear die arrangements utilized in line printers.

1. A punching station for perforating at least one sheet, and for disposal in line with a printer or other processing machine, the printer or other processing machine providing the sheet to the punching station at a first linear speed, the punching station comprising
a mouth disposed to receive said sheet from the printer or other processing machine,
a punch path disposed in series with the mouth and adapted to further receive the sheet,
at least one driven transporter disposed along the punch path to advance the sheet, said transporter adapted to advance the sheet at a second linear speed,
a die set having a throat disposed in line with the punch path to receive the sheet for punching,
an exit punch path disposed in series with the die set and adapted to receive the sheet from the die set,
at least one driven exit transporter disposed along the exit punch path to advance the sheet, said exit transporter adapted to advance the sheet to a third linear speed, at least one of the driven transporter or driven exit transporter accelerating the sheet, at least the second linear speed being greater than the first linear speed by an amount greater than necessary to maintain tension on the sheet, and
an exit mouth disposed in series with the exit punch path to deliver the sheet from the punching station.

2. The punching station of claim 1 wherein the punch path and the exit punch path define a generally loop shape.

3. The punching station of claim 1 wherein the second and third linear speeds are substantially the same.

4. The punching station of claim 1 further comprising a plurality of flanges which form a channel for slidably receiving the die set.

5. The punching station of claim 1 further comprising a bypass path disposed between the mouth and the exit mouth whereby said sheet may be advanced to bypass the die set entirely.

6. The punching station of claim 5 further comprising a diverter disposed to direct said sheet to either the bypass path or the punch path.

7. The punching station of claim 6 further comprising controls, said controls being operable to position the diverter.

8. The punching station of claim 1 further comprising at least one stepper motor disposed to control the operation of at least one of the transporter or exit transporter.

9. The punching station of claim 1 wherein the at least one driven transporter comprises at least one soft surface roller to form a soft nip such that the roller will be permitted to slip on the sheet in the soft nip until such time as the printer exerts no force on the sheet.

10. The punching station of claim 1 further comprising a second driven exit transporter disposed along the exit punch path in close proximity to the exit mouth.

11. The punching station of claim 10 further comprising a stepper motor coupled to the second driven exit transporter, the stepper motor operating to decrease the linear speed of the sheet.

12. The punching station of claim 10 wherein the second driven exit transporter comprises at least one soft surface roller to form a soft nip.

13. The punching station of claim 1 further comprising a manual feed path disposed to direct a manually feed a sheet to the die set, said manual feed path having a first end that opens to an operator-accessible slot and a second end that opens into at least one of the punch path or the die set.

14. The punching station of claim 1 wherein the die set is a dual action punch, and the punch path comprises a pair of punch paths disposed to direct sheets to alternately direct sheets to one side of the dual action punch or the other such that the dual action punch may alternately perforate sheets disposed on either side of said dual action punch.

15. The punching station of claim 1 further comprising a blade mounted to move between a first position wherein the blade obstructs the sheet advancing from the punch path to the die set such that said sheet is held in position for punching, and a second position wherein the blade does not obstruct the sheet advancing from the punch path to the die set such that the sheet continues on to the exit punch path without stopping within the die set.

16. The punching station of claim 1 further comprising at least one sensor disposed along one of the mouth or the punch path, said sensor being adapted to sense passage of the sheet, whereby the length of the sheet may be calculated.

17. The punching station of claim 15 further comprising at least one sensor disposed along one of the mouth or the punch path, said sensor being adapted to sense passage of the sheet, whereby the length of the sheet may be calculated and a signal provided to the blade to determine the position of the blade.

18. The punching station of claim 16 comprising at least a second sensor, said second sensor being disposed along the punch path, one of said sensors adapted to sense a first edge and second edge of said sheet and the other of the sensors being adapted to sense at least one of the first or second edge.

19. The punching station of claim 15 wherein said driven transporter comprises a soft nip comprising a driving element, the driving element being adapted to continue to drive the sheet into the die set but slip on the sheet when the sheet is disposed against the blade such that the driven transporter provides proper registration of sheet in the die set without buckling of the sheet.

20. A punch pin for use in perforating sheets, said punch pin being formed of powdered metal.

21. The punch pin of claim 20 wherein the punch pin is part of a punch pin plate comprising a plurality of such punch pins, said punch pin plate and punch pins being formed of powdered metal.

22. A punch pin plate for use in perforating sheets, said punch pin plate comprising a base plate and at least one punch pin extending from said base plate, said base plate and at least one punch pin being formed of powdered metal.

23. A method of making punch pins for use in perforating sheets, the method comprising the steps of
forming and compacting powdered metal into a punch pin form, and
heating the punch pin form.

24. The method of claim 23 wherein the forming and compacting step comprises the step of forming and compacting cold powdered metal, and the method further comprises the step of forging the heated punch pin form in a closed die.

25. The method of claim 23 wherein the heating step comprising the step of sintering the punch pin form in a controlled atmosphere furnace, and further comprising the step of allow the heated punch pin form to cool in the furnace.

26. The method of claim 23 further comprising the step of unitarily forming the punch pin with a plurality of such punch pins and a base plate from which said punch pins extend.

27. A die set for use in a punching machine to perforate a sheet, the punching machine being adapted to assert a punching force on the die set to perforate the sheet, the die set comprising
a die subassembly adapted to receive said sheet for punching, and
a pin retainer subassembly slidably coupled to the die subassembly, the pin retainer subassembly comprising at least one die pin having a head and an elongated shaft, and an elongated pin guide/retainer adapted to receive the die pin, the pin guide/retainer comprising an elongated, substantially U-shaped channel having a lower arm, a base extending substantially perpendicular from the lower arm, and an upper arm, the lower arm comprising at least one opening therethrough, the die pin extending through the opening such that the head is disposed within the U-shaped channel and the shaft extends outward from the lower arm and is slidably received by the die subassembly.

28. The die set of claim 27 wherein the die pin is formed of powdered metal.

29. The die set of claim 27 wherein the die set comprises a plurality of die pins, the heads of the die pins being connected to form an elongated die plate.

30. The die set of claim 27 wherein the die set comprises a plurality of said die pins having heads and shafts, each shaft having an axis, said die set further comprising an elongated pressure bar disposed substantially within the U-shaped channel adjacent the pin heads such that the pressure bar transmits the punching force to the pin heads, the pressure bar being coupled to the pin guide/retainer such that it is generally moveable within the U-shaped channel in a plane including said axes of the die pins, the pressure bar being tiltable within said plane such that the pressure bar may transmit the punching force to the pin heads sequentially.

31. The die set of claim 30 further comprising a spacer disposed within the U-shaped channel to limit movement of one end of the pressure bar within the plane.

32. The die set of claim 30 further comprising a biasing element disposed to exert a biasing force on the pressure bar to bias the pressure bar into engagement with the pin head.

33. The die set of claim 32 wherein the biasing element is a spring.

34. A method of punching a sheet in a punching station in line with a printer or other processing machine, the method comprising the steps of
receiving the sheet from the printer or other processing machine at a first linear speed,
advancing the sheet at a second linear speed greater than the first linear speed along a punch path,
substantially arresting the linear movement of the sheet when the sheet is positioned in a throat of a die set,
punching perforations in the sheet,
accelerating the sheet out of the die set to a third linear speed along an exit punch path, and
providing the sheet to a subsequent operation.

35. The method of claim 34 wherein the receiving step comprises the steps of receiving the sheet at a soft nip and allowing the sheet to slip within the soft nip if a force continues to be applied to the sheet by the printer or other processing machine.

36. The method of claim 34 wherein the substantially arresting step comprises the step of positioning a blade in the die set to prevent passage of the sheet therethrough.

37. The method of claim 34 further comprising the step of continuing to exert a transporting force to the sheet when it is disposed in an arrested position in the die set.

38. The method of claim 34 wherein the providing step comprises the step of decelerating the linear speed of the sheet to a fourth linear speed.

39. The method of claim 34 wherein the providing step comprises the steps of continuing to exert a transporting force to the sheet to form a controlled buckle in the sheet.

40. The method of claim 34 further comprising the steps of manually providing a second sheet to the die set via a manual feed path, and activating said die set to punch perforations in said second sheet.

41. The method of claim 34 further comprising the steps of diverting a second sheet to a bypass path, providing a transporting force to the second sheet, and providing the second sheet to a subsequent operation.

42. The method of claim 34 adapted to punch or bypass a plurality of sheets and further comprising the steps of
determining the length of said sheet,
comparing the length of said sheet to a preset sheet length or range of lengths, and
if said sheet is other than the preset length or range of lengths, then transporting said sheet along the punch path and through the die set without punching perforations in said sheet, transporting said sheet along the exit punch path, and providing said sheet to the subsequent operation, and
if said sheet is substantially the same as the preset sheet length or substantially within the preset range of lengths, then substantially arresting the linear movement of the sheet when the sheet is positioned in a throat of a die set, punching perforations in the sheet, accelerating the sheet out of the die set along an exit punch path, and providing the sheet to a subsequent operation.

43. The method of claim 42 wherein the step of determining the length of said sheet comprises the steps of sensing a first edge of said sheet, and sensing a second edge of said sheet.

44. The method of claim 43 wherein the step of determining the length of said sheet further comprises the steps of measuring the time lapse between the sensing of the first edge and the sensing of the second edge, and determining the length of the sheet based upon said time lapse and the linear speed of the sheet.

45. The method of claim 34 adapted to punch or bypass a plurality of sheets and further comprising the steps of
sensing a first edge of said sheet,
sensing a second edge of said sheet,
determining the time lapse between sensing the first edge and sensing the second edge,
comparing the time lapse to a preset time lapse or preset range of time lapses, and
if said time lapse is other than the preset time lapse or preset range of time lapses, then transporting said sheet along the punch path and through the die set without punching perforations in said sheet, transporting said sheet along the exit punch path, and providing said sheet to the subsequent operation, and
if said is substantially the same as the preset time lapse or substantially within the preset range of time lapses, then substantially arresting the linear movement of the sheet when said sheet is positioned in a throat of a die set, punching perforations in the sheet, accelerating the sheet out of the die set along an exit punch path, and providing the sheet to a subsequent operation.

46. The process of claim 45 wherein the steps of sensing the first edge of the sheet and sensing the second edge of the sheet comprise the steps of sensing the first edge using a first sensor, second edge of the sheet using said first sensor or a second sensor, further comprising the steps of sensing the first edge of the sheet using said second sensor, measuring a second time lapse between the sensing of the first edge by the first sensor and sensing the first edge by the second sensor, calculating a linear speed of the sheet based upon the second time lapse and a linear distance along the punch path between the first and second sensors, and determining the preset time lapse or preset range of time lapses based upon the linear speed and an optimum sheet length.

47. The punching station of claim 1 further comprising an angled aligner, said angled aligner comprising an aligner module and at least one roller mounted on the aligner module, said aligner module being moveable between a first position wherein the rollers are disposed to contact said sheet, and a second position wherein the rollers are disposed to not contact the sheet, the angled aligner further comprising a solenoid operable to move the aligner module between the first and second positions.

48. An angled aligner for use in directing a sheet in a sheet processing machine, the angled aligner comprising an aligner module and at least one roller mounted on the aligner module, said aligner module being moveable between a first position wherein the rollers are disposed to contact said sheet, and a second position wherein the rollers are disposed to not contact the sheet, the angled aligner further comprising a solenoid operable to move the aligner module between the first and second positions.
